(19) United States
(12) Patent Application Publication
(10) Pub. No.: US 2003/0220770 A1
(43) Pub. Date: Nov. 27, 2003

(54) Design rule generating system

(75) Inventor: Katsumi Eikyu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/270,539

(22) Filed: Oct. 16, 2002

(30) Foreign Application Priority Data
May 23, 2002 (JP) 2002-148871

(51) Int. Cl. G06F 17/50

(52) U.S. Cl. 703/1

(57) ABSTRACT

On the basis of layout information and process information, a three-dimensional TCAD conducts simulations of a three-dimensional structure while taking adversely-affecting device phenomena into account and outputs electric characteristic data corresponding to design rules defined in the layout information for the same number of times as the number of plural pieces of design rule information. A simulation result accumulating portion accumulates the electric characteristic data obtained from the three-dimensional TCAD and provides the accumulated electric characteristic data that are associated with the plural pieces of design rule information. Then, on the basis of the accumulated electric characteristic data, a design rule determining portion determines from among the plural pieces of design rule information the optimum design rule information that satisfies a reference value and outputs it as determined design rule information.

### BACKGROUND OF THE INVENTION

1. Field of the Invention

The present invention relates to a design rule generating system which generates design rules for designing a semiconductor device such as an LSI.

2. Description of the Background Art

Conventionally, the generation of design rules tended to depend greatly on the evaluation of actual measurements about electric characteristics obtained with TEGs (Test Element Groups) and on the succession of conventional trends.

FIG. 16 is a flowchart showing the procedure of a conventional design rule generating method. The contents of the conventional design rule generating process will now be described referring to this diagram.

First, in Step S1, the design rules of the previous generation are read in and the scale of reduction is set in Step S2.

Subsequently, it is decided in Step S3 whether the design rule can be simply scaled down; when simply scaling down is possible (Y (Yes)), then the previous-generation design rule read in Step S1 is shrunk on the scale set in Step S2 and the design rule D. R is thus set.

On the other hand, if the decision in Step S3 is N (NO), the flow moves to Step S4. In Step S4, it is checked whether values actually measured with, e.g. TEGs, are available; when actually measured values are available, Step S5 performs calculation on the basis of the TEG measurements to set the design rule D. R.

On the other hand, if no actual measurements are available (N in Step S4), then the design rule D. R. is manually set by the engineer in Step S6 on the basis of the engineer's knowledge, past experience, etc. The processing in Step S6 may depend on the intuition of the engineer.

In the conventional design rule generating method, if values actually measured with TEGs etc. are available, then the design rules D. R. can be set on the basis of the actually measured values.

Thus, when generating design rules for a new process, if the design rule cannot be simply scaled down, conducting the Steps S4 and S5 requires making a TEG while taking into consideration various process conditions and variations about ion implantation, thermal process, thickness and shape of photoresist in lithography, etc. and evaluating the values actually measured with the TEG.

However, phenomena that cannot be completely evaluated with TEG always exist depending on the contents of the process, and such phenomena have to be considered by manual design by the engineer (Step S6).

When the design is manually created by the engineer, setting too large a design margin may lead to an increase in chip area, and setting too small a margin may cause a failure in the chip designed according to the design rules, which will be found out after the manufacture to raise the need for redesign.

The conventional design rule generating process conducted as shown above thus has a problem that it is difficult to take into consideration phenomena that are not evaluated on the basis of actual measurements with TEGs etc, so as to generate precise design rules.

### SUMMARY OF THE INVENTION

It is an object of the invention is to obtain a design rule generating system which can generate precise design rules while taking into consideration phenomena that are not evaluated with actually measured values.

According to the present invention, a design rule generating system includes information providing means, a simulation executing portion, and a design rule determining portion.

The information providing means provides plural pieces of layout information including plural pieces of design rule information and process information about a predetermined semiconductor device. On the basis of the layout information and the process information, the simulation executing portion executes a predetermined simulation including process simulation and device simulation while taking into consideration a predetermined adversely-affecting device phenomenon, thereby obtaining plural pieces of electric characteristic data about the predetermined semiconductor device respectively according to the plural pieces of design rule information. On the basis of the plural pieces of electric characteristic data respectively corresponding to the plural pieces of design rule information, the design rule determining portion determines design rule information which satisfies a predetermined reference from among the plural pieces of design rule information as determined design rule information to output the determined design rule information.

The simulation executing portion performs a predetermined simulation including process simulation and device simulation while taking into account a predetermined adversely-affecting device phenomenon, whereby, even when the predetermined adversely-affecting device phenomenon is not evaluated with actual measurements, precise design rules can be generated selectively from the plural pieces of design rule information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a design rule generating system according to a first preferred embodiment of the invention;

FIG. 2 is an explanation diagram mainly showing the flow of data in the design rule generating system of the first preferred embodiment shown in FIG. 1;

FIG. 3 is a block diagram showing the configuration of a design rule generating system according to a second preferred embodiment of the invention;

FIG. 4 is an explanation diagram mainly showing the flow of data in the design rule generating system of the second preferred embodiment shown in FIG. 3;

FIG. 5 is a block diagram showing the configuration of a design rule generating system having a design rule verification function according to a third preferred embodiment of the invention;

FIG. 6 is an explanation diagram mainly showing the flow of data in the design rule generating system of the third preferred embodiment shown in FIG. 5;

FIG. 7 is a block diagram showing the configuration of a design rule generating system having a design rule verification function according to a fourth preferred embodiment of the invention;

FIG. 8 is an explanation diagram mainly showing the flow of data in the design rule generating system of the fourth preferred embodiment shown in FIG. 7;

FIG. 9 is an explanation diagram showing an example of setting of a design rule in an MOS transistor;

FIG. 10 is an explanation diagram showing a shallow pocket implant process;

FIG. 11 is a sectional view showing an example of setting of a shadowing margin;

FIG. 12 is a graph showing a relation between the shadowing margin and off-state leakage current;

FIG. 13 is a plan view showing an example of setting of punch-through margins;

FIG. 14 shows the B-B section of FIG. 13;

FIG. 15 is a graph showing a relation between the punch-through margin and breakdown voltage; and

FIG. 16 is a flowchart showing the procedure of a conventional design rule generating method.

### DESCRIPTION OF THE PREFERRED EMBODIMENTS

<Shadowing (Phenomenon)>

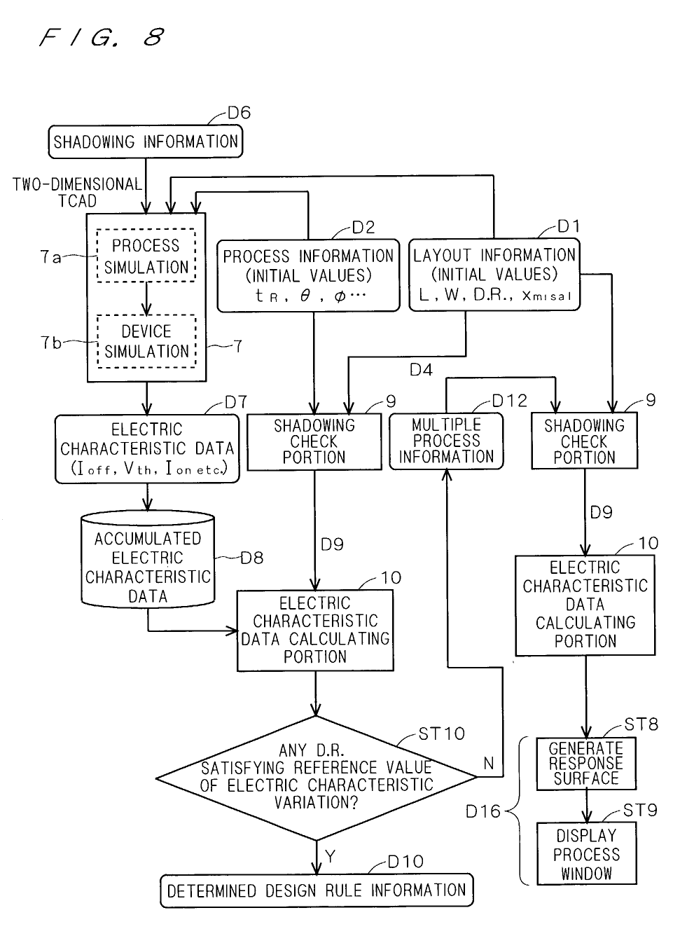

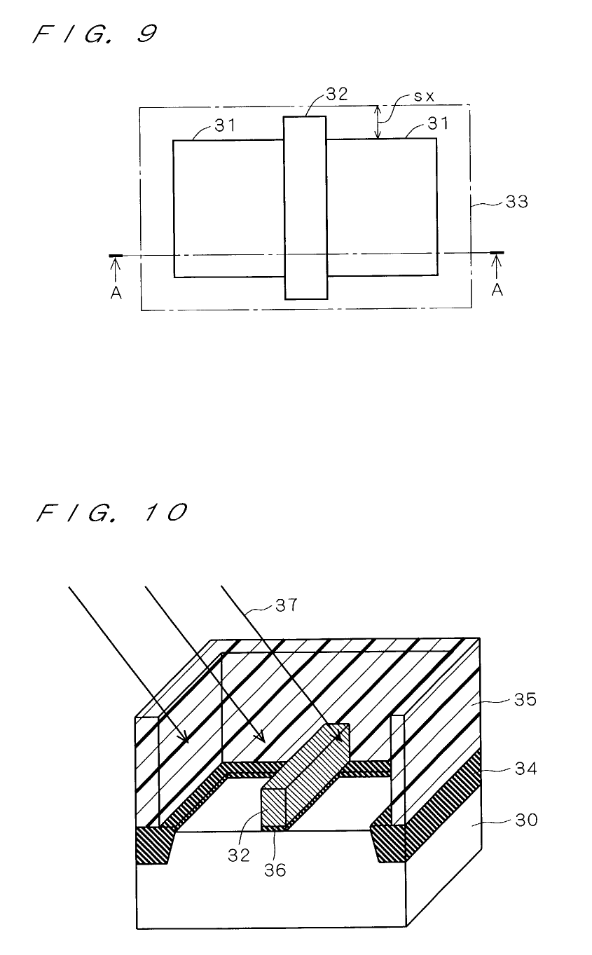

FIG. 9 is an explanation diagram showing an example of setting of a design rule in an MOS transistor. As shown in this diagram, in the manufacture of an MOS transistor having a gate electrode 32 between source/drain regions 31, 31, the design rules include the shadowing margin sx which is a margin set between the region 33 intended for formation of the transistor and the source/drain regions 31.

FIG. 10 is an explanation diagram showing a process of shallow pocket implantation (also called halo implantation). As shown in this diagram, the upper part of the semiconductor substrate 30 is element-isolated by an element isolation region 34 and the gate insulating film 36 and the gate electrode 32 are formed in the isolated region, with photoresist 35 covering the area other than the transistor formation region on the semiconductor substrate 30. In this condition, shallow pocket region is formed by a tilted ion implantation in which ions 37 are obliquely implanted. Such tilted ion implantation is conducted also during LDD formation.

The tilted ion implantation may be affected by shadowing (phenomenon), where the photoresist 35 and the gate electrode 32 block the implantation of the ions 37. When shadowing occurs, the active region, e.g. the pocket region, may be formed with ions implanted insufficiently. When the active region exhibits a lower impurity implant level than designed, the electric characteristics will not satisfy the reference values, e.g. the threshold voltage may be lowered, which will lead to inferior operation of the manufactured chip.

To solve this problem, the design rule has to be set in such a way as to entirely prevent the effect of shadowing, or to reduce the effect of shadowing so that the variations of electric characteristics of the transistor satisfy the reference values.

FIG. 11 is a sectional view showing an example of setting of the shadowing margin. As shown in this diagram, when ions 37 are obliquely implanted at an ion-implant tilt angle θ of 45°, the shadowing margin sx from the edge of the gate electrode 32 is set as a design rule. That is to say, it is necessary to set the minimum shadowing margin sx within the range in which the electric characteristics of the MOS transistor are not deteriorated.

FIG. 12 is a graph showing the relation between the shadowing margin sx and the off-state leakage current Ioff. As shown in this diagram, the off-state leakage current Ioff can be suppressed to a certain value when the shadowing margin sx is set at m0 or larger. Thus setting the design rule of the shadowing margin sx at m0 allows an enhanced degree of integration while minimizing the off-state leakage current Ioff, one of the electric characteristics of the MOS transistor.

<Punch-through>

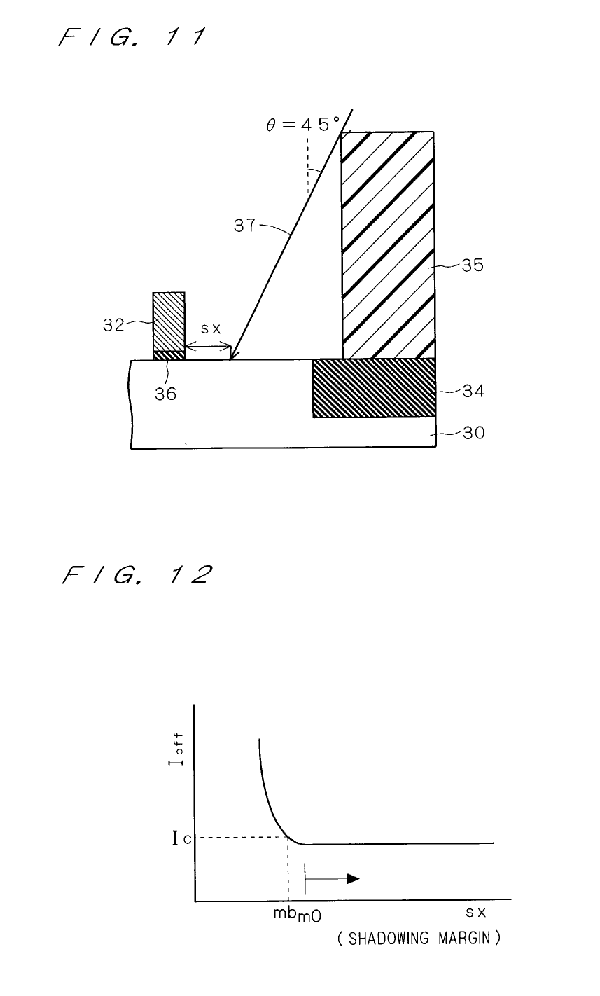

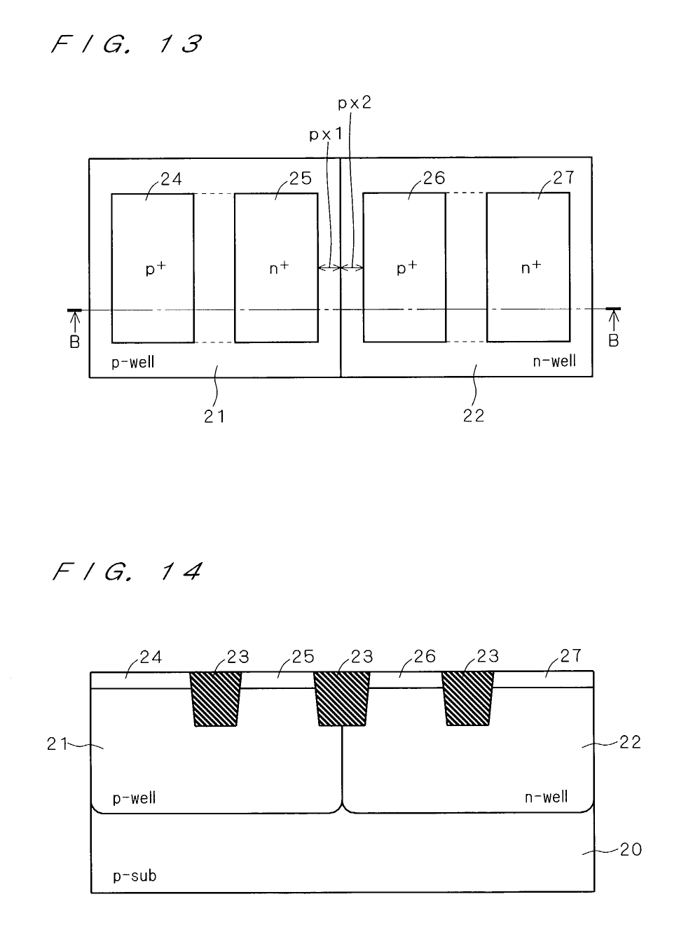

FIG. 13 is a plan view showing an example of setting of the punch-through margin. FIG. 14 shows the B-B section of FIG. 13.

As shown in the diagrams, a P well region 21 and an N well region 22 are formed adjacent each other in the upper part of a P-type substrate 20, with a P⁺ diffusion region 24 as a contact region and an N⁺ diffusion region 25 as a transistor active region formed in the surface of the P well region 21, and with an N⁺ diffusion region 27 as a contact region and a P⁺ diffusion region 26 as a transistor active region formed in the N well region 22.

Also, element isolation regions 23 are formed in the upper part of the P-type substrate 20 between the P⁺ diffusion region 24 and the N+diffusion region 25, between the N⁺ diffusion region 25 and the P⁺ diffusion region 26, and between the P+diffusion region 26 and the N⁺ diffusion region 27.

In this structure, it is necessary to set optimum punch-through margins px1 and px2 between the N⁺ diffusion region 25 and the P⁺ diffusion region 26. The punch-through margin px1 defines the base width of the NPN bipolar transistor formed by the N⁺ diffusion region 25, the P well region 21 and the N well region 22, and the punch-through margin px2 defines the base width of the PNP bipolar transistor formed by the P⁺ diffusion region 26, the N well region 22 and the P well region 21.

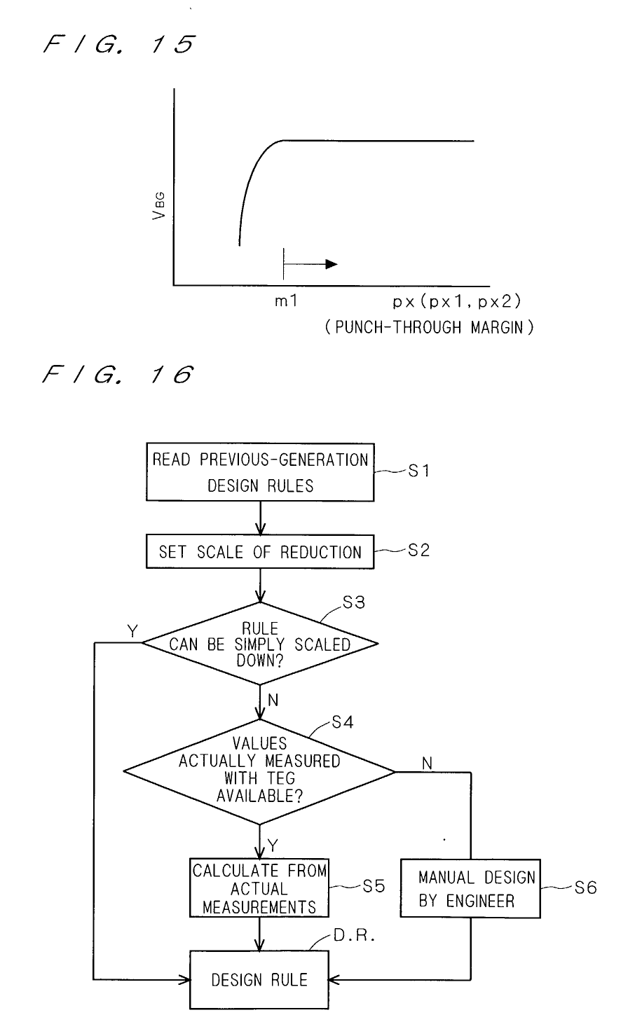

FIG. 15 is a graph showing the relation between the punch-through margin px and the breakdown voltage VBG. As shown in this diagram, the breakdown voltage VBG can be set at a relatively high constant value when the punch-through margin px is set at ml or larger. Thus setting the punch-through margin px at ml allows an enhanced integration level while ensuring an appropriate level of breakdown voltage VBG, one of the electric characteristics of the MOS transistor.

Now, phenomena which adversely affect the device, like the shadowing and punch-through, are referred to as “adversely-affecting device phenomena” and the first to fourth preferred embodiments below will now describe design rule generating systems that precisely generate optimum design rules while taking such adversely-affecting device phenomena into consideration.

<First Preferred Embodiment>

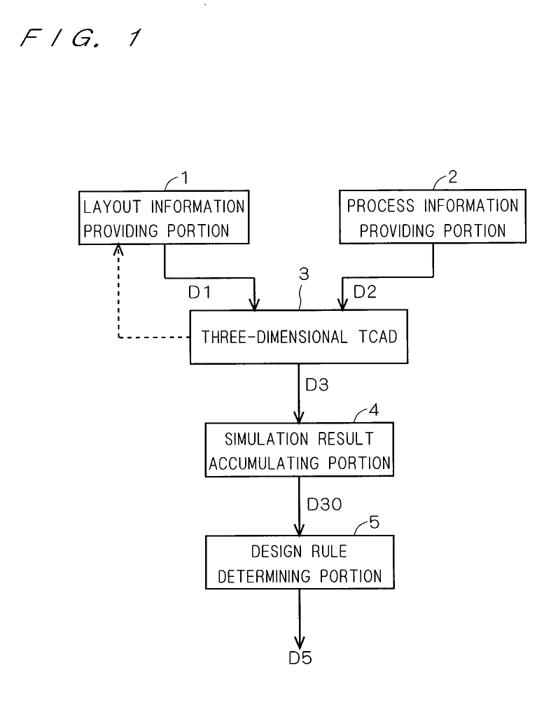

FIG. 1 is a block diagram showing the configuration of a design rule generating system according to a first preferred embodiment of the invention.

As shown in this diagram, a layout information providing portion 1 and a process information providing portion 2 respectively provide layout information D1 and process information D2 about a predetermined semiconductor device, e.g. an MOS transistor, to a three-dimensional TCAD (Technology-Computer-Aided Design) 3. As will be described later in greater detail, the layout information D1 shown in FIG. 1 includes plural pieces of layout information which define plural pieces of design rule information among which one or a plurality of design rules are varied.

The three-dimensional TCAD 3 is capable of performing integrated simulations including process simulation and device simulation of three-dimensional structure. On the basis of the layout information D1 and the process information D2, the three-dimensional TCAD 3 performs the simulation while taking adversely-affecting device phenomena into consideration, so as to obtain electric characteristic data D3 corresponding to the design rules defined by the layout information D1, as many times as the number of pieces of the design rule information.

A simulation result accumulating portion 4 accumulates the electric characteristic data D3 obtained by the three-dimensional TCAD 3 and provides accumulated electric characteristic data D30 that contain plural pieces of electric characteristic data associated with the plural pieces of design rule information.

On the basis of the accumulated electric characteristic data D30, the design rule determining portion 5 determines the optimum design rule information that satisfies reference value from among the plural pieces of design rule information, and outputs it as the determined design rule information D5.

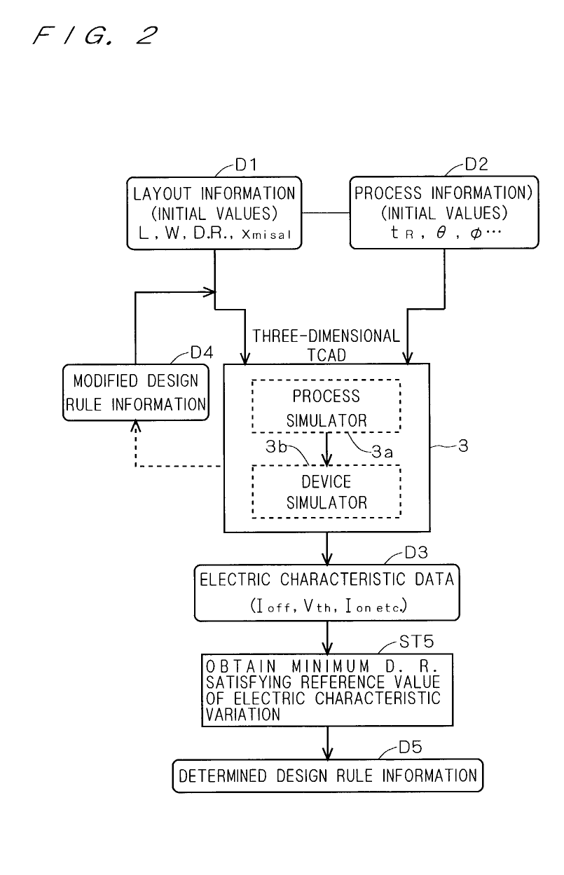

FIG. 2 is an explanation diagram chiefly showing the flow of data in the design rule generating system of the first preferred embodiment shown in FIG. 1. The design rule generating operation by the design rule generating system of the first preferred embodiment is now described referring to FIGS. 1 and 2.

The layout information D1 and the process information D2 are captured into the three-dimensional TCAD 3. The layout information D1 includes the gate length L, gate width W, design rules D. R., amount of misalignment, xmisal, etc., where the design rules D. R. include, for example, the shadowing margin sx, the punch-through margins px, etc. as explained earlier. The process information D2 includes the resist film thickness tR, ion-implant tilt angle θ, ion-implant rotation angle φ, etc.

On the basis of the layout information D1 and the process information D2, the three-dimensional TCAD 3 drives the process simulator 3a and the device simulator 3b to execute three-dimensional process simulation and device simulation while taking into consideration the adversely-affecting device phenomena, so as to calculate the electric characteristic data D3 associated with the design rules D. R. defined by the layout information D1. The electric characteristic data D3 includes the off-state leakage current Ioff, threshold voltage Vth, on-state current (or driving current) Ion, etc.

The three-dimensional TCAD 3 controls the layout information providing portion 1 to cause it to output new layout information D1 that contains modified design rule information D4 in which one or a plurality of design rules D. R. have been modified.

Then, on the basis of the process information D2 and the new layout information D1 with the modified design rule information D4, the three-dimensional TCAD 3 calculates the electric characteristic data D3 as described above. Subsequently, each time modified design rule information 4 is set, the three-dimensional TCAD 3 calculates the electric characteristic data D3 on the basis of the new layout information D1 and the process information D2.

As a result, the simulation result accumulating portion 4 can accumulate the accumulated electric characteristic data D30 that is composed of plural pieces of electric characteristic data D3 obtained in correspondence with the plural pieces of design rule information including the initial design rule information and the modified design rule information D4.

After that, in Step ST5, the design rule determining portion 5 selects from among the plural pieces of design rule information the minimum-dimension design rule information with which the electric characteristic variation satisfies the reference value and determines it as the determined design rule information D5. For example, when the accumulated electric characteristic data D30 provides the relation shown in FIG. 12 between the shadowing margin sx and the off-state leakage current Ioff, where the reference value of the off-state leakage current Ioff is set at Ic, then the shadowing margin sx=mb is determined as the determined design rule D5.

As a result, the design rule generating system of the first preferred embodiment can generate precise design rules that can achieve an enhanced degree of integration while certainly suppressing the adversely-affecting device phenomena including shadowing, punch-through, etc., without the need to obtain actually measured values.

For example, the reference values are defined as follows: the absolute value of the off-state leakage current Ioff should be less than 1.5 times the off-state leakage current Ioff0 with no shadowing (|Ioff|<1.5|Ioff0|); the threshold voltage variation Δ Vth should be less than 50 mV (Δ Vth <50 mV); the ratio of the absolute value of the on-state current variation A Ion with respect to the on-state current Ion0 with no shadowing should be less than 5% (|ΔIon|/|Ion0|<0.05).

Information about the amount of mask alignment error (hereinafter referred to simply as “the amount of mask misalignment”) may be incorporated in the layout information D1. In this case, the design rules can be generated while considering the amount of mask misalignment.

That is to say, the design rule generating system of the first preferred embodiment determines the design rules so that the electric characteristic variations satisfy reference values even when mask misalignment occurs, and therefore the dimensions of margins can be smaller than when the amount of mask misalignment is simply added to the design rule obtained with no mask misalignment, which enables the generation of design rules adapted for higher integration on the practical level.

In the first preferred embodiment, without the need to reduce the number of dimensions, the three-dimensional TCAD 3 can three-dimensionally simulate adversely-affecting device phenomena which should substantially be three-dimensionally recognized, e.g. shadowing, thus providing highly accurate simulation results. However, the simulation time and the amount of memory used during calculation tend to increase.

The three-dimensional TCAD 3 may be previously calibrated by giving it actual measurements about electric characteristics of the MOS transistor, so as to enhance the precision of simulation (the precision of calculation of the electric characteristic data D3), and then further precise design rules can be generated.

<Second Preferred Embodiment>

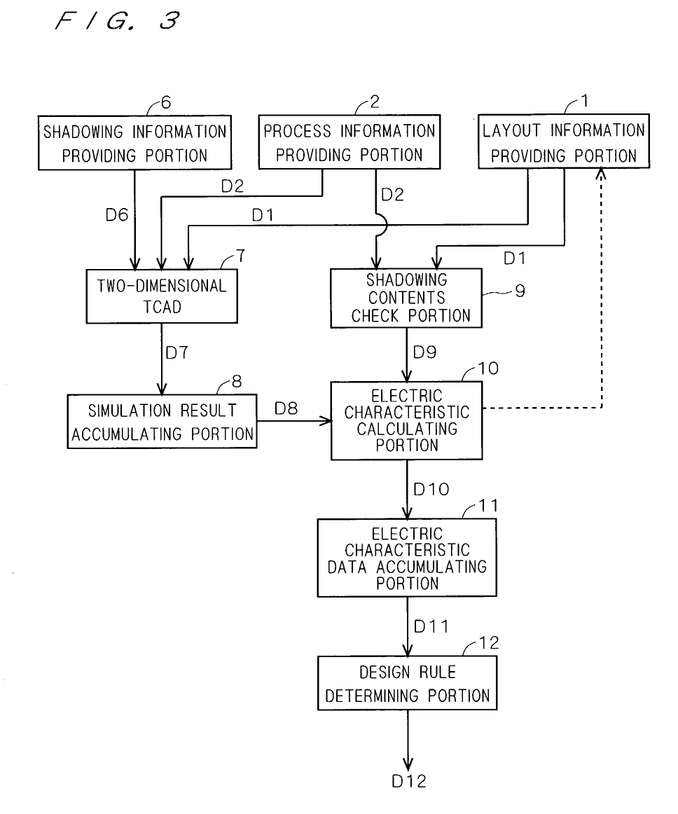

FIG. 3 is a block diagram showing the configuration of a design rule generating system according to a second preferred embodiment of the invention. This preferred embodiment shows a design rule generating system which can take into consideration the shadowing in MOS transistors.

As shown in this diagram, the layout information providing portion 1, the process information providing portion 2, and a shadowing information providing portion 6 respectively supply MOS transistor layout information D1, process information D2 and shadowing information D6, to a two-dimensional TCAD 7.

The two-dimensional TCAD 7 is capable of performing integrated simulations including process simulation and device simulation of two-dimensional structure. On the basis of the layout information D1 and the process information D2, the two-dimensional TCAD 7 conducts the simulation for each shadowing type defined by the shadowing information D6 and obtains electric characteristic data D7. The shadowing types include a type in which the shadowing effect is absent, a type in which the shadowing affects the tilted ion implantation from a predetermined one direction, a type in which the shadowing affects the tilted ion implantation from a plurality of predetermined directions, for example.

Herein, “two-dimensional structure” means a two-dimensional structure like the section A-A shown in FIG. 9 which is obtained by cutting the MOS transistor along the gate length direction (or along the direction perpendicular to the gate width).

The simulation result accumulating portion 8 accumulates the electric characteristic data D7 for each shadowing type, as accumulated electric characteristic data D8.

The shadowing check portion 9 divides the MOS transistor at fine slicing intervals Δ y in the gate width W direction to obtain a plurality of divided two-dimensional structures, like the A-A section shown in FIG. 9. Then, on the basis of the layout information D1, the shadowing check portion 9 takes into consideration the tilt angle θ in tilted ion-implantation, the ion-implant rotation angle φ, the resist film thickness tR, the divided shape, etc., to output shadowing check results D9 in which the corresponding shadowing types are assigned to the individual divided two-dimensional structures.

On the basis of the accumulated electric characteristic data D8 and the shadowing check results D9, the electric characteristic calculating portion 10 extracts simulation results which correspond to the respective shadowing types assigned to the plurality of divided two-dimensional structures, collectively calculates simulation results for the individual divided two-dimensional structures, and outputs the calculated electric characteristic data D10.

Thus the calculated electric characteristic data D10 finally provides, in an approximating manner, electric characteristic data about the three-dimensionally structured MOS transistor which corresponds to one piece of design rule information D. R. For example, when the electric characteristic data includes the off-state leakage current Ioff, it multiplies the off-state leakage current per unit length of each divided two-dimensional structure by the fine slicing interval A y and performs integration in the gate width W direction to obtain the off-state leakage current Ioff in one MOS transistor.

The electric characteristic data accumulating portion 11 accumulates the electric characteristic data D10 obtained from the electric characteristic calculating portion 10 to provide the accumulated electric characteristic data D1 associated with the plural pieces of design rule information.

Then, on the basis of the accumulated electric characteristic data D11, the design rule determining portion 12 determines the optimum design rule information that satisfies the reference value, which is outputted as the determined design rule information D12.

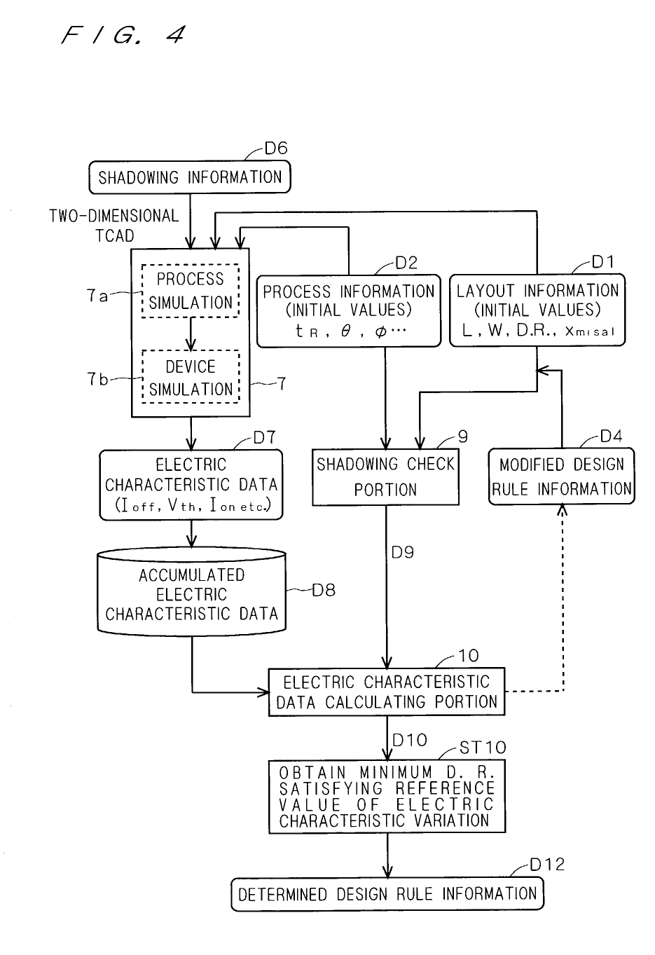

FIG. 4 is an explanation diagram mainly showing the flow of data in the design rule generating system of FIG. 3 of the second preferred embodiment. The design rule generating operation by the design rule generating system of the second preferred embodiment is now described referring to FIGS. 3 and 4.

The layout information D1, process information D2 and shadowing information D6 are captured into the two-dimensional TCAD 7.

On the basis of the layout information D1, process information D2 and shadowing information D6, the two-dimensional TCAD 7 drives the process simulator 7a and the device simulator 7b to perform two-dimensional process simulation and device simulation for each shadowing type defined by the shadowing information D6 and outputs the electric characteristic data D7.

The electric characteristic data D7, for each shadowing type, is accumulated in the simulation result accumulating portion 8 (not shown in FIG. 4) as the accumulated electric characteristic data D8.

The layout information D1 and the process information D2 are captured into the shadowing check portion 9 and the shadowing check portion 9 obtains the shadowing check results D9 as described earlier and outputs them to the electric characteristic calculating portion 10.

Then, on the basis of the accumulated electric characteristic data D8 and the shadowing check results D9, the electric characteristic calculating portion 10 outputs the calculated electric characteristic data D10 as described above.

Further, the electric characteristic calculating portion 10 controls the layout information providing portion 1 to cause it to output new layout information D1 that contains modified design rule information D4 in which one or a plurality of design rules D. R. have been modified.

Then, on the basis of the new layout information D1 and the process information D2, the shadowing check portion 9 outputs the shadowing check results D9 corresponding to the modified design rule information D4 and the electric characteristic calculating portion 10 outputs the calculated electric characteristic data D10 corresponding to the new, modified design rule information D4 on the basis of the accumulated electric characteristic data D8 and the new shadowing check results D9.

Subsequently, each time modified design rule information D4 is set, the shadowing check portion 9 and the electric characteristic calculating portion 10 calculate the calculated electric characteristic data D10 on the basis of the new layout information D1 and the process information D2.

As a result, the electric characteristic data accumulating portion 11 accumulates the accumulated electric characteristic data D11 that provides plural pieces of electric characteristic data D10 associated with the plural pieces of design rule information including the initial design rule information and at least one piece of modified design rule information D4.

After that, in Step ST10, the design rule determining portion 12 determines from among the plural pieces of design rule information the minimum-dimension design rule information with which the electric characteristic variation satisfies the reference value and determines it as the determined design rule information D112.

Thus, the design rule generating system of the second preferred embodiment can generate design rules that can achieve an enhanced degree of integration while certainly suppressing the shadowing phenomenon, without the need to obtain actual measurements. The second preferred embodiment has described the shadowing as an example, but, of course, it is also possible to similarly generate design rules suppressing other adversely-affecting device phenomena like punch-through.

In the second preferred embodiment, as in the first preferred embodiment, information about the amount of mask misalignment may be incorporated in the layout information D1 so as to generate design rules adapted for higher integration on the practical level.

In the second preferred embodiment, where the two-dimensional TCAD 7 conducts simulations with two-dimensionally structured data, the simulation time and the amount of memory used for calculation can be reduced. However, the precision of the design rules is somewhat lower than in the first preferred embodiment, because three-dimensional phenomena are calculated in a pseudo manner on the basis of the results of two-dimensional simulations. However, the deterioration of precision raises no serious problem because the punch-through phenomenon can be almost correctly evaluated by two-dimensional simulations.

The system configuration tends to be complicated because of the need to post-process the accumulated electric characteristic data D8 in the shadowing check portion 9, the electric characteristic calculating portion 10, and the like.

The two-dimensional TCAD 7 may be previously calibrated by giving it actual measurements about electric characteristics of the MOS transistor, so as to enhance the precision of simulation (the precision of calculation of the electric characteristic data D7), and then further precise design rules can be generated.

<Third Preferred Embodiment>

FIG. 5 is a block diagram showing the configuration of a design rule generating system having a design rule verification function according to a third preferred embodiment of the invention.

As shown in this diagram, the layout information providing portion 1 and the process information providing portion 2 respectively supply the layout information D1 and the process information D2 to the three-dimensional TCAD 3. The three-dimensional TCAD 3 also receives multiple process information D13 from a multiple process information providing portion 13.

In normal operation (in the design rule generating mode), the three-dimensional TCAD 3, as in the first preferred embodiment, performs the three-dimensional simulations on the basis of the layout information D1 and the process information D2 while considering adversely-affecting device phenomena, and obtains the electric characteristic data D3.

On the other hand, in the design rule verification mode, the three-dimensional TCAD 3 performs the simulation on the basis of the layout information D1 and the multiple process information D13 and obtains multiple-process electric characteristic data D3p. Note that, in the design rule verification mode, the layout information D1 means the layout information that defines the initial values of the design rules.

During normal operation, as in the first preferred embodiment, the simulation result accumulating portion 4 accumulates the electric characteristic data D3 obtained from the three-dimensional TCAD 3 and provides the accumulated electric characteristic data D30 corresponding to plural pieces of design rule information.

The instruction indicating the normal mode (the design rule generating mode) or the design rule verification mode to the three-dimensional TCAD 3 is made by the design rule determining portion 5. The normal mode is set in the initial state.

Then, on the basis of the accumulated electric characteristic data D30, the design rule determining portion 5 determines the optimum design rule information and outputs it as the determined design rule information D5. At this time, when it is unable to determine the optimum design rule information, the design rule determining portion 5 changes the instruction from the normal mode (the design rule generating mode) to the design rule verification mode.

The simulation result display portion 15 displays simulation results D15 on the basis of accumulated electric characteristic data D3p.

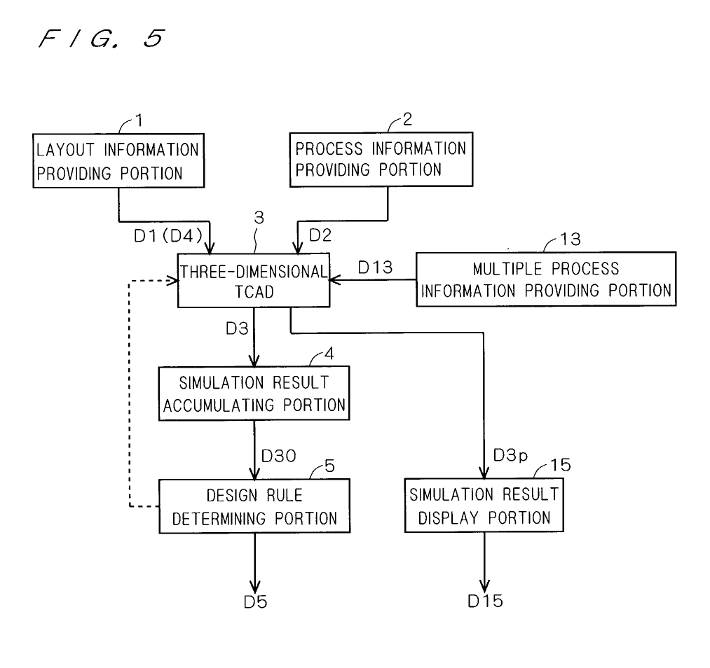

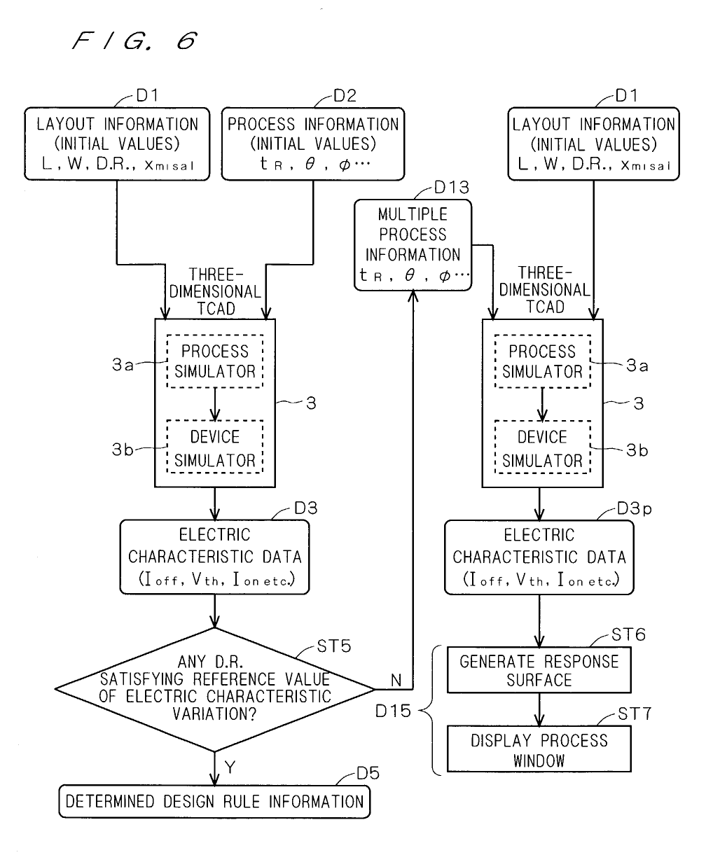

FIG. 6 is an explanation diagram mainly showing the flow of data in the design rule generating system according to the third preferred embodiment shown in FIG. 5. The design rule generating operation by the design rule generating system of the third preferred embodiment is now described referring to FIGS. 5 and 6.

The process steps to “Y” in Step ST5 shown on the left side in FIG. 6 are the same as those of FIG. 2 of the first preferred embodiment and therefore they are not described again. The process steps performed after the decision “N” in Step ST5 are now described.

When the decision N is made in Step ST5, the design rule determining portion 5 gives an instruction to the three-dimensional TCAD 3 to change the mode to the design rule verification mode.

Then, on the basis of the layout information D1 and the multiple process information D13, the three-dimensional TCAD 3 drives the process simulator 3a and the device simulator 3b to perform three-dimensional process simulation and device simulation, so as to calculate the multiple-process electric characteristic data D3p with the process conditions defined by the multiple process information D13 and with the initial-value design rule information defined in the layout information D1. For the multiple-process electric characteristic data D3p, the parameters, such as the resist film thickness tR, ion-implant tilt angle θ, and ion-implant rotation angle φ, are varied in the process condition ranges defined by the multiple process information D13.

After that, in Step ST6, the simulation result display portion 15 generates a response surface (shape data showing electric characteristic data in a region defined by two or more process parameters) on the basis of the multiple-process electric characteristic data D3p, and then in Step ST7, it displays a process window showing the appropriate range for each process parameter. The response surface and process window form the simulation results D15.

As shown above, in addition to the effects of the first preferred embodiment, when the design rule determining portion 5 is unable to obtain the optimum design rule information, the design rule generating system of the third preferred embodiment offers the simulation results D15 as verification data that serve as indications of good process conditions with a predetermined piece of design rule information.

It is also possible in the design rule verification mode to perform the design rule verification for each of the plural pieces of design rule information by obtaining the simulation results D15 while varying the design rules.

<Fourth Preferred Embodiment>

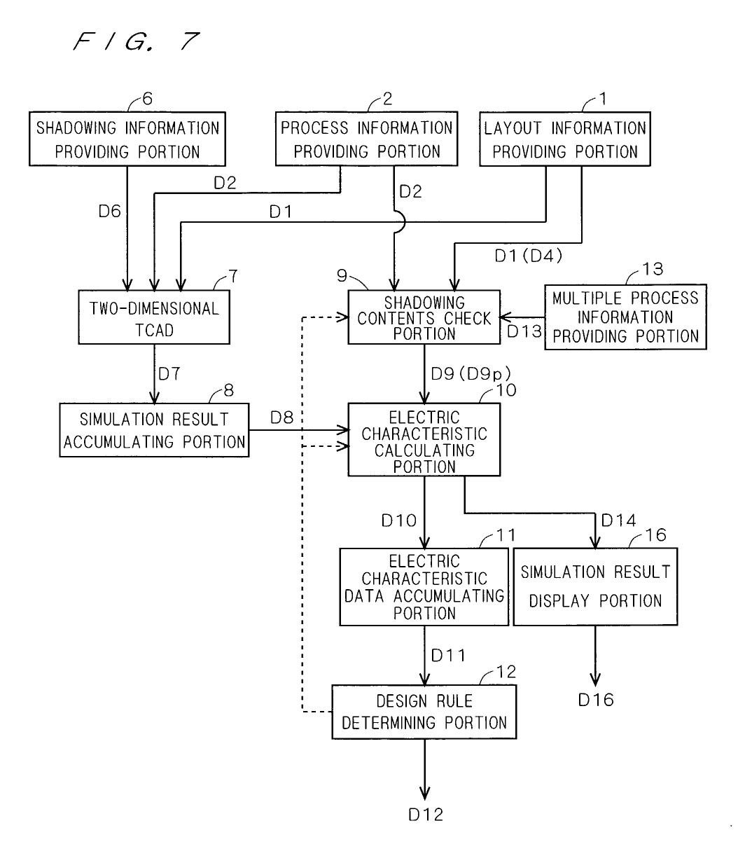

FIG. 7 is a block diagram showing the configuration of a design rule generating system having a design rule verification function according to a fourth preferred embodiment of the invention. In this preferred embodiment, design rules are generated while taking the shadowing in an MOS transistor into account.

The two-dimensional TCAD 7, and the layout information providing portion 1, the process information providing portion 2, and the shadowing information providing portion 6, which are in input/output relation with the two-dimensional TCAD 7, and the electric characteristic data accumulating portion 11 and the design rule determining portion 12 are the same as those shown in FIG. 3 in the second preferred embodiment and, therefore they are not described again here.

As shown in this diagram, as in the second preferred embodiment, the shadowing check portion 9, in the normal operation, outputs the shadowing check results D9 in which the corresponding shadowing types are assigned to a plurality of divided two-dimensional structures, on the basis of the layout information D1 and the process information D2.

On the other hand, in the design rule verification mode, the shadowing check portion 9 outputs, on the basis of the layout information D1 and the multiple process information D13, the shadowing check results D9p reflecting the multiple process information D13 with a predetermined piece of design rule information.

As in the second preferred embodiment, in the normal operation, the electric characteristic calculating portion 10 outputs the calculated electric characteristic data D10 on the basis of the accumulated electric characteristic data D8 and the shadowing check results D9.

On the other hand, in the design rule verification mode, the electric characteristic calculating portion 10 outputs the multiple-process calculated electric characteristic data D14 on the basis of the accumulated electric characteristic data D8 and the shadowing check results D9p.

The simulation result display portion 16 obtains simulation results D16 on the basis of the multiple-process calculated electric characteristic data D14.

FIG. 8 is an explanation diagram mainly showing the flow of data in the design rule generating system of the fourth preferred embodiment shown in FIG. 7. The design rule generating operation by the design rule generating system of the fourth preferred embodiment is now described referring to FIGS. 7 and 8. The process steps to the decision Y in Step ST10 are the same as the process flow of the second preferred embodiment shown in FIG. 4 and therefore they are not described again here; the process steps following the decision N in Step ST10 are now described which are performed when no design rule information satisfies the reference value of the electric characteristic variation.

When the decision in Step ST10 is N, the design rule determining portion 12 changes the contents of the instruction to the shadowing check portion 9 and the electric characteristic calculating portion 10 to change the mode from the normal operation to the design rule verification mode.

Then the shadowing check portion 9 outputs the shadowing check results D9p on the basis of the layout information D1 and the multiple process information D12.

Then the electric characteristic calculating portion 10 outputs the multiple-process calculated electric characteristic data D14 on the basis of the accumulated electric characteristic data D8 and the shadowing check results D9p.

After that, the simulation result display portion 16 generates in Step ST8 a response surface on the basis of the multiple-process calculated electric characteristic data D14 and then in Step ST9 it displays a process window showing the proper range region for each process parameter. The response surface and process window form the simulation results D16.

As shown above, in addition to the effect of the second preferred embodiment, when the optimum design rule cannot be found, the design rule generating system of the fourth preferred embodiment provides the simulation results D16 as verification data which serve as indications of good process conditions.

In the design rule verification mode, it is also possible to perform design rule verification for each of the plural pieces of design rule information by obtaining the simulation results D16 while varying the design rules.

While the invention has been described in detail, the foregoing description is in all aspects illustrative and not restrictive. It is understood that numerous other modifications and variations can be devised without departing from the scope of the invention.

What is claimed is:

1. A design rule generating system comprising:
information providing means for providing plural pieces of layout information and process information about a predetermined semiconductor device, said plural pieces of layout information including plural pieces of design rule information;
a simulation executing portion for executing a predetermined simulation including process simulation and device simulation while taking into consideration a predetermined adversely-affecting device phenomenon, thereby obtaining plural pieces of electric characteristic data about said predetermined semiconductor device respectively according to said plural pieces of design rule information, on the basis of said layout information and said process information; and
a design rule determining portion for determining design rule information which satisfies a predetermined reference from among said plural pieces of design rule information as determined design rule information to output said determined design rule information on the basis of said plural pieces of electric characteristic data respectively corresponding to said plural pieces of design rule information.

2. The design rule generating system according to claim 1, further comprising:
a multiple process information providing portion for providing multiple process information that provides varied process conditions, wherein
when said design rule determining portion is unable to determine said design rule information satisfying said predetermined reference, said design rule determining portion sets said simulation executing portion in a design rule verification mode, and
said simulation executing portion obtains electric characteristic data about said predetermined semiconductor device with a predetermined piece of design rule information, while reflecting said multiple process information in said design rule verification mode, on the basis of said layout information containing said predetermined piece of design rule information and said multiple process information,
and said design rule generating system further comprising:
a process simulation result output portion for outputting a process simulation result which defines process conditions with said predetermined piece of design rule information satisfying said predetermined reference, on the basis of said electric characteristic data reflecting said multiple process information.

3. The design rule generating system according to claim 1, wherein
said predetermined simulation includes a three-dimensional simulation in which said predetermined adversely-affecting device phenomenon is directly simulated as a three-dimensional phenomenon.

4. The design rule generating system according to claim 1, further comprising:
an adverse effect type information providing portion for providing adverse effect type information defining types of the predetermined adversely-affecting device phenomenon, wherein
said predetermined simulation includes a two-dimensional simulation in which said predetermined adversely-affecting device phenomenon is simulated as a two-dimensional phenomenon defined by first and second directional components,
and said simulation executing portion includes:
a two-dimensional simulation executing portion for executing said two-dimensional simulation on the basis of said layout information, said process information, and said adverse effect type information, so as to obtain a two-dimensional simulation result for each type of said adversely-affecting device phenomenon;
an adversely-affecting device phenomenon type check portion for checking to see the type of said predetermined adversely-affecting device phenomenon for each unit length along a predetermined direction defined by a third directional component differing from said first and second directional components, on the basis of said layout information and said process information; and
an electric characteristic data calculating portion for approximating said predetermined adversely-affecting device phenomenon as a three-dimensional phenomenon to obtain said electric characteristic data, on the basis of said two-dimensional simulation results obtained for each type of said predetermined adversely-affecting device phenomenon and the types of said predetermined adversely-affecting device phenomenon determined for each unit length along said predetermined direction.

5. The design rule generating system according to claim 1, wherein
said predetermined adversely-affecting device phenomenon includes a shadowing phenomenon which occurs when a barrier exists during an ion implantation.

6. The design rule generating system according to claim 1, wherein
said predetermined adversely-affecting device phenomenon includes a punch-through phenomenon.
